(19) United States
(12) Patent Application Publication
(10) Pub. No.: US 2020/0322795 A1
(43) Pub. Date: Oct. 8, 2020

(54) APPARATUSES AND METHODS FOR ALIGNMENT OF COMMON NON ACCESS STRATUM (NAS) SECURITY CONTEXT

(71) Applicant: MediaTek Singapore Pte. Ltd., Singapore (SG)

(72) Inventors: Jarkko ESKELINEN, Oulu (FI); Marko NIEMI, Oulu (FI)

(21) Appl. No.: 16/833,784

(22) Filed: Mar. 30, 2020

Related U.S. Application Data
(60) Provisional application No. 62/828,558, filed on Apr. 3, 2019.

(51) Int. Cl. H04W 12/04; H04W 36/00; H04W 12/10; H04W 12/08; H04W 12/00

(52) U.S. Cl. CPC H04W 12/0401; H04W 36/0038; H04W 12/0023; H04W 12/10; H04W 12/0806; H04W 12/04031

(57) ABSTRACT

A UE receives a first NAS Security Mode Command message or a NAS Container, which includes an indication to change a common NAS security context that is in use on both accesses, from a 33GP core network over one access, when the UE is in a connected state on both accesses and the UE is using the common NAS security context on both accesses. In response, the UE activates a new NAS security context over the one access. After that, the UE receives a second NAS Security Mode Command message, which includes a KSI associated with the common NAS security context, from the 3GPP core network over the other access, and aligns the common NAS security context in use on the other access with the new NAS security context in use on the one access.

### CROSS REFERENCE TO RELATED APPLICATIONS

This application claims priority of U.S. Provisional Application No. 62/828,558, filed on Apr. 3, 2019, the entirety of which is incorporated by reference herein.

### BACKGROUND OF THE APPLICATION

### Field of the Application

The application generally relates to security context handling, and more particularly, to apparatuses and methods for alignment of common Non Access Stratum (NAS) security context.

### Description of the Related Art

In a typical mobile communication environment, a User Equipment (UE) (also called Mobile Station (MS)), such as a mobile telephone (also known as a cellular or cell phone), or a tablet Personal Computer (PC) with wireless communications capability, may communicate voice and/or data signals with one or more service networks. Wireless communications between the UE and the service networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc.

These RAT technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

According to the 3GPP specifications and/or requirements in compliance with the 5G NR technology, a UE must have a common Non Access Stratum (NAS) security context for both 3GPP access and non-3GPP access when the UE is registered with the same Access and Mobility Management Function (AMF) over both 3GPP access and non-3GPP access. However, the common NAS security context may become unaligned over non-3GPP access when a NAS Security Mode Command (SMC) procedure is triggered to run over 3GPP access to update the NAS security context in use on 3GPP access. That is, a new NAS security context will be activated on 3GPP access, while the old NAS security context (i.e., the common NAS security context) is still in use on non-3GPP access. The current 3GPP specifications and/or requirements in compliance with the 5G NR technology do not define specific UE behaviors regarding how to detect if a NAS SMC procedure triggered to run over non-3GPP access later is meant to align the NAS security contexts within the UE.

### BRIEF SUMMARY OF THE APPLICATION

In order to solve the aforementioned problem, the present application proposes specific ways for a UE to receive explicit indication to align the NAS security contexts on both accesses when the common NAS security context is unaligned.

In one aspect of the application, a UE which is communicatively connected to a 3rd Generation Partnership Project (3GPP) core network over a 3GPP access and a non-3GPP access and is using a common Non Access Stratum (NAS) security context on both the 3GPP access and the non-3GPP access is provided. The UE comprises a wireless transceiver and a controller. The wireless transceiver is configured to perform wireless transmission and reception to and from the 3GPP access and the non-3GPP access. The controller is configured to communicate with the 3GPP core network over the 3GPP access and the non-3GPP access via the wireless transceiver, wherein the communication with the 3GPP core network comprises: receiving a first NAS Security Mode Command message or a NAS Container (NASC), which includes an indication to change the common NAS security context, from the 3GPP core network over one of the 3GPP access and the non-3GPP access; in response to receiving the first NAS Security Mode Command message or the NASC over the one access, activating a new NAS security context over the one access; after activating the new NAS security context over the one access, receiving a second NAS Security Mode Command message, which comprises a KSI associated with the common NAS security context, from the 3GPP core network over the other access of the 3GPP access and the non-3GPP access; and in response to receiving the second NAS Security Mode Command message over the other access, aligning the common NAS security context in use on the other access with the new NAS security context in use on the one access.

In another aspect of the application, a method for alignment of common NAS security context, executed by a UE which is communicatively connected to a 3GPP core network over a 3GPP access and a non-3GPP access and is using a common Non Access Stratum (NAS) security context on both the 3GPP access and the non-3GPP access, is provided. The method comprises the steps of: receiving a first NASC, which includes an indication to change the common NAS security context, from the 3GPP core network over one of the 3GPP access and the non-3GPP access; in response to receiving the first NAS Security Mode Command message or the NASC over the one access, activating a new NAS security context over the one access; after activating the new NAS security context over the one access, receiving a second NAS Security Mode Command message, which comprises a KSI associated with the common NAS security context, from the 3GPP core network over the other access of the 3GPP access and the non-3GPP access; and in response to receiving the second NAS Security Mode Command message over the other access, aligning the common NAS security context in use on the other access with the new NAS security context in use on the one access.

Other aspects and features of the present application will become apparent to those with ordinarily skill in the art upon review of the following descriptions of specific embodiments of the UEs and methods method for alignment of common NAS security context.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIG. 3 is a flow chart illustrating the method for alignment of common NAS security context according to an embodiment of the application; and

FIG. 4 is a message sequence chart illustrating alignment of common NAS security context within a UE according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

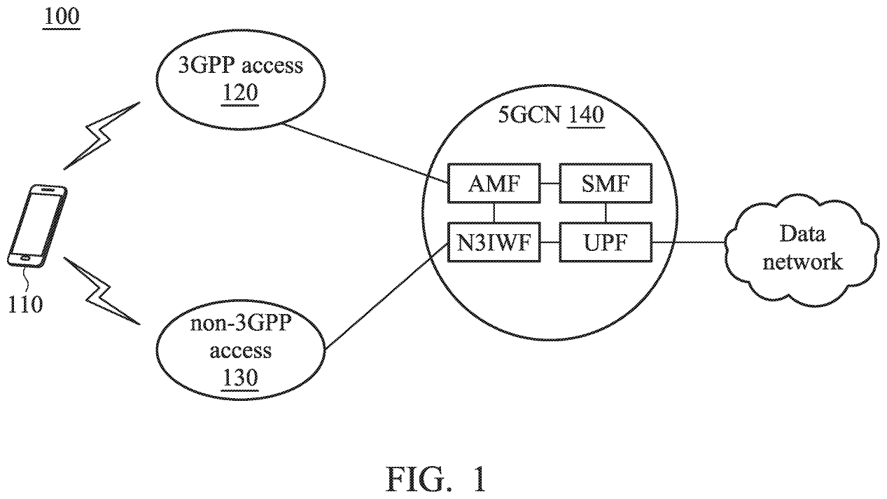

FIG. 1 is a block diagram of a wireless communication environment according to an embodiment of the application.

The wireless communication environment 100 includes a UE 110, a 3GPP access 120, a non-3GPP access 130, and a 3GPP core network which is exemplified by a 5G Core Network (5GCN) 140.

The UE 110 may be a feature phone, a smartphone, a tablet PC, a laptop computer, or any wireless communication device supporting the RATs utilized by the 3GPP access 120, the non-3GPP access 130, and the 5GCN 140.

The UE 110 may be wirelessly connected to the 5GCN 140 via the 3GPP access 120 and/or the non-3GPP access 130. For example, the UE 110 may communicate with the 5GCN 140 over the 3GPP access 120 and/or the non-3GPP access 130 to obtain mobile services therefrom.

The 3GPP access 120 may refer to an access network utilizing one of the RATs specified by 3GPP. For example, the 3GPP access 120 may include a GSM EDGE Radio Access Network (GERAN), Universal Terrestrial Radio Access Network (UTRAN), Evolved UTRAN (E-UTRAN), or Next Generation Radio Access Network (NG-RAN).

In one embodiment, the 3GPP access 120 may include a GERAN if the utilized RAT is the GSM/EDGE/GPRS technology, and the GERAN may include at least a Base Transceiver Station (BTS) and a Base Station Controller (BSC).

In one embodiment, the 3GPP access 120 may include a UTRAN if the utilized RAT is the WCDMA technology, and the UTRAN may include at least one NodeB (NB).

In one embodiment, the 3GPP access 120 may include an E-UTRAN if the utilized RAT is the LTE/LTE-A/TD-LTE technology, and the E-UTRAN may include at least one evolved NodeB (eNB) (e.g., macro eNB, femto eNB, or pico eNB).

In one embodiment, the 3GPP access 120 may include an NG-RAN if the utilized RAT is the 5G NR technology, and the NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases.

The non-3GPP access 130 may refer to an access network utilizing one RAT not specified by 3GPP. For example, the non-3GPP access 130 may include a Wireless-Fidelity (Wi-Fi) network, a WiMAX network, a CDMA network, or a fixed network (e.g., a Digital Subscriber Line (DSL) network).

Each of the 3GPP access 120 and the non-3GPP access 130 is capable of providing the functions of processing radio signals, terminating radio protocols, and connecting the UE 110 with the 5GCN 140, while the 5GCN 140 is responsible for performing mobility management, network-side authentication, and interfaces with a public/external data network (e.g., the Internet).

The 5GCN 140 may also be called a Next Generation Core Network (NG-CN) in the 5G NR technology, and it may support various network functions, including an Access and Mobility Management Function (AMF), a Session Management Function (SMF), a User Plane Function (UPF), a Policy Control Function (PCF), an Application Function (AF), an Authentication Server Function (AUSF), and a Non-3GPP Inter-Working Function (N3IWF), wherein each network function may be implemented as a network element on dedicated hardware, or as a software instance running on dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs. The N3IWF may enable the UE 110 to attach to the 5GCN 140 either via trusted non-3GPP access or via untrusted non-3GPP access.

It should be understood that the 5GCN 140 depicted in FIG. 1 is for illustrative purposes only and are not intended to limit the scope of the application. For example, the UE 110 may be wirelessly connected to other 3GPP core networks (e.g., future evolution of the 5GCN, such as 6GCN, and 7GCN, etc.) over the 3GPP access 120 and/or the non-3GPP access 130.

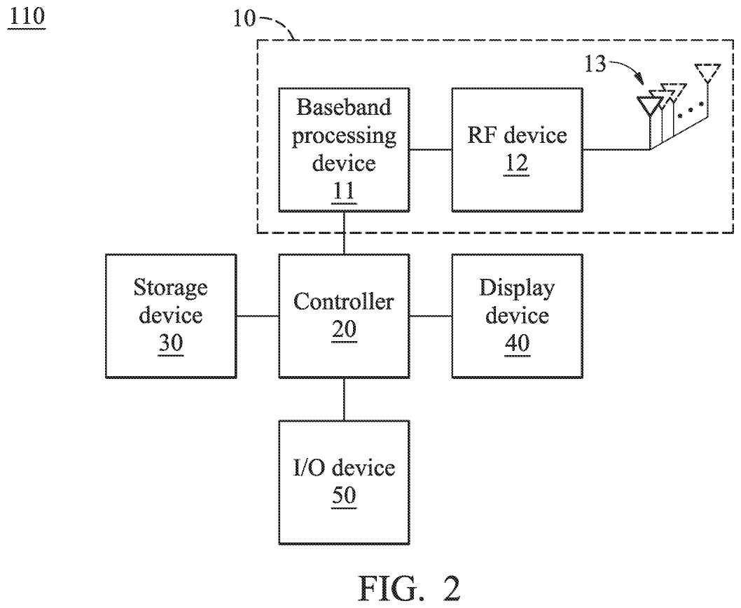

FIG. 2 is a block diagram illustrating the UE 110 according to an embodiment of the application.

The UE 110 may include a wireless transceiver 10, a controller 20, a storage device 30, a display device 40, and an Input/Output (I/O) device 50.

The wireless transceiver 10 is configured to perform wireless transmission and reception to and from a 3GPP access (e.g., the 3GPP access 120) and/or a non-3GPP access (e.g., the non-3GPP access 130). Specifically, the wireless transceiver 10 includes a baseband processing device 11, a Radio Frequency (RF) device 12, and antenna(s) 13, wherein the antenna(s) 13 may include one or more antennas for beamforming. The baseband processing device 11 is configured to perform baseband signal processing and control the communications between subscriber identity card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 12 may receive RF wireless signals via the antenna(s) 13, convert the received RF wireless signals to baseband signals, which are processed by the baseband processing device 11, or receive baseband signals from the baseband processing device 11 and convert the received baseband signals to RF wireless signals, which are later transmitted via the antenna(s) 13. The RF device 12 may also contain multiple hardware devices to perform radio frequency conversion. For example, the RF device 12 may include a mixer to multiply the baseband signals with a carrier oscillated in the radio frequency of the supported cellular technologies, wherein the radio frequency may be 900 MHz, 1800 MHz or 1900 MHz utilized in 2G (e.g., GSM/EDGE/GPRS) systems, or may be 900 MHz, 1900 MHz or 2100 MHz utilized in 3G (e.g., WCDMA) systems, or may be 900 MHz, 2100 MHz, or 2.6 GHz utilized in 4G (e.g., LTE/LTE-A/TD-LTE) systems, or may be any radio frequency (e.g., 30 GHz-300 GHz for mmWave) utilized in 5G (e.g., NR) systems, or another radio frequency, depending on the RAT in use.

In another embodiment, the wireless transceiver 10 may include multiple sets of a baseband processing device, an RF device, and an antenna, wherein each set of a baseband processing device, an RF device, and an antenna is configured to perform wireless transmission and reception using a respective RAT.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless transceiving with 3GPP access and/or non-3GPP access, enabling the storage device 30 and storing and retrieving data (e.g., 5G security parameters: Key Set Identifier for Next Generation Radio Access Network (ngKSI), security key K_{AMF}, and algorithms for integrity protection and ciphering, etc.) to and from the storage device 30, sending a series of frame data (e.g. representing text messages, graphics, images, etc.) to the display device 40, and receiving/outputting signals from/to the I/O device 50.

In particular, the controller 20 coordinates the aforementioned operations of the wireless transceiver 10, the storage device 30, the display device 40, and the I/O device 50 for performing the method for alignment of common NAS security context.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium which may include any combination of the following: a Subscriber Identity Module (SIM) or Universal SIM (USIM), a non-volatile memory (e.g., a FLASH memory or a Non-Volatile Random Access Memory (NVRAM)), a magnetic storage device (e.g., a hard disk or a magnetic tape), and an optical disc. A SIM/USIM may contain SIM/USIM application containing functions, file structures, and elementary files, and it may be technically realized in the form of a physical card or in the form of a programmable SIM (e.g., eSIM) that is embedded directly into the UE 110. The storage device 30 may be used for storing data, including NAS security context(s), and instructions and/or program code of applications, communication protocols, and/or the method for alignment of common NAS security context.

In one embodiment, when the UE 110 is registered with the same AMF in the 5GCN 140 over both the 3GPP access 120 and the non-3GPP access 130, the UE 110 may have a common NAS security context for both 3GPP access and non-3GPP access. Specifically, the common NAS security context may be divided into a common part and an access-specific part. The common part may include an ngKSI, a K_{AMF}, and algorithms for integrity protection and ciphering, and it may be applied for both 3GPP access and non-3GPP access. The access-specific part may include, for each access type, an access identifier, keys for integrity and ciphering, and a pair of NAS message count parameters for uplink and downlink.

The display device 40 may be a Liquid-Crystal Display (LCD), a Light-Emitting Diode (LED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users, such as receiving user inputs, and outputting prompts to users.

It should be understood that the components described in the embodiment of FIG. 2 are for illustrative purposes only and are not intended to limit the scope of the application. For example, the UE 110 may include more components, such as a power supply, or a Global Positioning System (GPS) device, wherein the power supply may be a mobile/replaceable battery providing power to all the other components of the UE 110, and the GPS device may provide the location information of the UE 110 for use of some location-based services or applications. Alternatively, the UE 110 may include fewer components. For example, the UE 110 may not include the display device 40 and/or the I/O device 50.

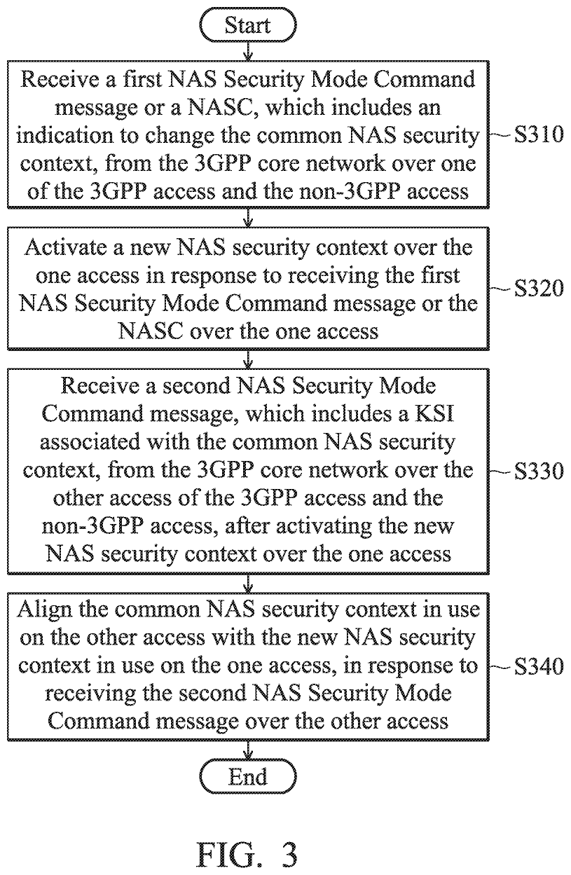

FIG. 3 is a flow chart illustrating the method for alignment of common NAS security context according to an embodiment of the application.

In this embodiment, the method for alignment of common NAS security context is applied to and executed by a UE (e.g., the UE 110). Specifically, the UE is communicatively connected to a 3GPP core network (e.g., the 5GCN 140) over both a 3GPP access (e.g., the 3GPP access 120) and a non-3GPP access (e.g., the non-3GPP access 130) (i.e., the UE is in a connected state on both the 3GPP access and the non-3GPP access), and is using a common NAS security context on both the 3GPP access and the non-3GPP access.

Specifically, the UE is registered with the 3GPP core network over both the 3GPP access and the non-3GPP access, and the common NAS security context is established at the time of a first registration with the 3GPP core network over any one of the 3GPP access and the non-3GPP access, and the connected state may be a Connection Management (CM)-CONNECTED state.

To begin with, the UE receives a first NAS Security Mode Command message or a NAS Container (NASC), which includes an indication to change the common NAS security context, from the 3GPP core network over one access of the 3GPP access and the non-3GPP access (step S310).

The common NAS security context may include a Key Set Identifier (KSI) (e.g., a Key Set Identifier for Next Generation Radio Access Network (ngKSI)) which is used to identify the common NAS security context, and the first NAS Security Mode Command message or the NASC may include the same KSI to indicate that the common NAS security context is required to derive a new security key. In addition, the first NAS Security Mode Command message or the NASC may include other security parameters, such as selected algorithms for integrity protection and ciphering.

In one embodiment, the indication to change the common NAS security context may be the K_AMF_change_flag in the NASC according to the 3GPP Technical Specification (TS) 24.501, and the K_AMF_change_flag may be set to a value (e.g., 1) representing “a new K_{AMF} has been calculated by the network”.

In another embodiment, the indication to change the common NAS security context may be the Horizontal Derivation Parameter (HDP) in the additional 5G security parameters Information Element (IE) in the first NAS Security Mode Command message according to the 3GPP TS 24.501, and the HDP may be set to a value (e.g., 1) representing “K_{AMF} derivation is required”.

Subsequent to step S310, the UE activates a new NAS security context over the one access in response to receiving the first NAS Security Mode Command message or the NASC over the one access (step S320).

Specifically, before activating the new NAS security context, the UE may perform horizontal derivation of K_{AMF} and/or any other modification of security context according to the security parameters in the first NAS Security Mode Command message or the NASC, to obtain the new NAS security context.

Please note that the detailed description regarding horizontal derivation of K_{AMF} and modification of security context is omitted herein as it is beyond the scope of the application. Reference may be made to the 3GPP TS 33.501 for the detailed description regarding horizontal derivation of K_{AMF} and modification of security context.

In one embodiment, if the 3GPP core network is a 5G core network, the common NAS security context in use on the other access may include a first ngKSI, a first security key K_{AMF}, and first algorithms for integrity protection and ciphering, while the new NAS security context in use on the one access may include a second ngKSI, a second security key K′_{AMF}, and second algorithms for integrity protection and ciphering.

That is, the common NAS security context that was in use on both accesses has become unaligned. In other words, a new NAS security context is in use on the one access, while the common NAS security context is in use only on the other access.

Subsequent to step S320, the UE receives a second NAS Security Mode Command message, which includes a KSI associated with the common NAS security context, from the 3GPP core network over the other access of the 3GPP access and the non-3GPP access, after activating the new NAS security context over the one access (step S330).

Subsequent to step S330, the UE aligns the common NAS security context in use on the other access with the new NAS security context in use on the one access, in response to receiving the second NAS Security Mode Command message over the other access (step S340), and the method ends.

Specifically, the aligning of the common NAS security context in use on the other access with the new NAS security context in use on the one access may include: deleting the common NAS security context in use on the other access; and taking the new NAS security context in use on the one access into use on the other access (i.e., using the new NAS security context on both accesses).

In one embodiment, the aligning of the common NAS security context in use on the other access with the new NAS security context in use on the one access may be performed in response to the second NAS Security Mode Command message including the KSI associated with the common NAS security context that is already in use on the other access.

In another embodiment, the second NAS Security Mode Command message may further include an indication to align NAS security contexts within the UE, and the aligning of the common NAS security context in use on the other access with the new NAS security context in use on the one access may be performed in response to the second NAS Security Mode Command message including the indication to align NAS security contexts within the UE.

For example, the indication to align NAS security contexts within the UE may be the HDP in the additional 5G security parameters IE according to the 3GPP TS 24.501, and the HDP may be set to a value (e.g., 1) representing “K_{AMF} derivation is not required”. Tables 1˜2 below show an example of the additional 5G security parameters IE that includes the HDP as the indication to align NAS security contexts within the UE.

TABLE 1

| 8 | 7 | 6 | 5 | 4 | 3 | 2 | 1 | |
|---|---|---|---|---|---|---|---|---|
| Additional 5G security parameters IEI | | | | | | | | octet 1 |
| Length of Additional 5G security parameters contents | | | | | | | | octet 2 |
| 0 | 0 | 0 | 0 | 0 | 0 | RINMR | HDP | octet 3 |
| Spare | Spare | Spare | Spare | Spare | Spare | | | |

TABLE 2
Horizontal derivation parameter (HDP) (octet 3, bit 1)

| | |
|---|---|
| 0 | K_{AMF} derivation is not required |
| 1 | K_{AMF} derivation is required |

Retransmission of initial NAS message request (octet 3, bit 2)

| | |
|---|---|
| 0 | Retransmission of the initial NAS message not requested |
| 1 | Retransmission of the initial NAS message requested |

Bits 3 to 8 of octet 3 are spare and shall be coded as zero.

Alternatively, the indication to align NAS security contexts within the UE may be a new parameter introduced into the additional 5G security parameters IE, and the new parameter may be set to a value (e.g., 1) representing “Alignment of NAS security contexts is required”. Tables 3˜4 below show an example of the additional 5G security parameters IE that include the new parameter (e.g., ALIGN).

TABLE 3

| 8 | 7 | 6 | 5 | 4 | 3 | 2 | 1 | |
|---|---|---|---|---|---|---|---|---|
| Additional 5G security parameters IEI | | | | | | | | octet 1 |
| Length of Additional 5G security parameters contents | | | | | | | | octet 2 |
| 0 | 0 | 0 | 0 | 0 | ALIGN | RINMR | HDP | octet 3 |
| Spare | Spare | Spare | Spare | Spare | | | | |

TABLE 4
Horizontal derivation parameter (HDP) (octet 3, bit 1)

| | |
|---|---|
| 0 | K_{AMF} derivation is not required |
| 1 | K_{AMF} derivation is required |

Retransmission of initial NAS message request (octet 3, bit 2)

| | |
|---|---|
| 0 | Retransmission of the initial NAS message not requested |
| 1 | Retransmission of the initial NAS message requested |

Align NAS security contexts (ALIGN) (octet 3, bit 3)

| | |
|---|---|
| 0 | Alignment of NAS security contexts is not required |
| 1 | Alignment of NAS security contexts is required |

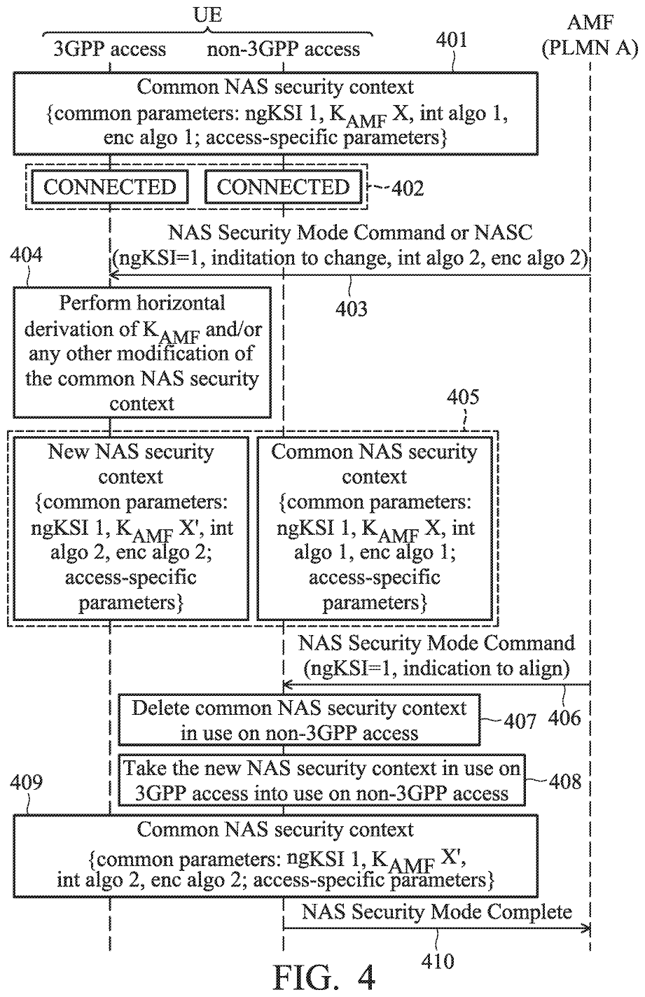

FIG. 4 is a message sequence chart illustrating alignment of common NAS security context within a UE according to an embodiment of the application.

In this embodiment, the UE (e.g., the UE 110) is registered with an AMF in a 5GCN (e.g., the 5GCN 140) over both a 3GPP access (e.g., the 3GPP access 120) and a non-3GPP access (e.g., the non-3GPP access).

In block 401, the UE is using a common NAS security context on both the 3GPP access and the non-3GPP access.

Specifically, the common NAS security context may be established at the time of a first registration with the AMF over any one of the 3GPP access and the non-3GPP access, and the common NAS security context may include security parameters that are common for both the 3GPP access and the non-3GPP access (referred to herein as common security parameters), and security parameters that are specific for each access type (referred to herein as access-specific security parameters).

The common security parameters may include an ngKSI (exemplified as “ngKSI 1” in FIG. 4), a security key K_{AMF} (exemplified as “K_{AMF} X” in FIG. 4), and algorithms for integrity protection and ciphering (exemplified as “int algo 1” and “enc algo 1” in FIG. 4). The access-specific security parameters may include, for each access type, an access identifier, keys for integrity and ciphering, and a pair of NAS message count parameters for uplink and downlink (not shown in FIG. 4).

In block 402, the UE is in a connected state (e.g., the CM-CONNECTED state) on both the 3GPP access and the non-3GPP access.

In block 403, the UE receives a NAS Security Mode Command message or a NASC from the AMF over the 3GPP access.

Specifically, the NAS Security Mode Command message or the NASC may include security parameters, such as the ngKSI associated with the common NAS security context (exemplified as “ngKSI 1” in FIG. 4), an indication to change the common NAS security context (exemplified as “indication to change” in FIG. 4), and algorithms for integrity protection and ciphering (exemplified as “int algo 2” and “enc algo 2” in FIG. 4).

In one embodiment, the indication to change the common NAS security context may be the K_AMF_change_flag in the NASC according to the 3GPP TS 24.501, and the K_AMF_change_flag may be set to a value (e.g., 1) representing “a new K_{AMF} has been calculated by the network”.

In another embodiment, the indication to change the common NAS security context may be the HDP in the additional 5G security parameters IE in the NAS Security Mode Command message according to the 3GPP TS 24.501, and the HDP may be set to a value (e.g., 1) representing “K_{AMF} derivation is required”.

The indication to change the common NAS security context may indicate a change to the KSI (and the security key K_{AMF} corresponding to the KSI) and/or a change to the algorithms for integrity protection and ciphering in the common NAS security context for the 3GPP access.

In block 404, the UE performs horizontal derivation of K_{AMF} and/or any other modification of the common NAS security context (e.g., modification of the algorithms for integrity protection and ciphering), since the NAS Security Mode Command message or the NASC includes a KSI associated with the common NAS security context and an indication to change the common NAS security context.

In block 405, the UE activates a new NAS security context over the 3GPP access, causing unalignment of the common NAS security context.

Specifically, the new NAS security context is different from the common NAS security context. For example, the common security parameters of the new NAS security context may include an ngKSI (exemplified as “ngKSI 1” in FIG. 4), a new security key K_{AMF} (exemplified as “K_{AMF} X′” in FIG. 4), and algorithms for integrity protection and ciphering (exemplified as “int algo 2” and “enc algo 2” in FIG. 4).

On the other hand, the common NAS security context is still in use on the non-3GPP access. As a result, the common NAS security context becomes unaligned on the 3GPP access and the non-3GPP access.

In block 406, the UE receives a NAS Security Mode Command message from the AMF over the non-3GPP access.

Specifically, the NAS Security Mode Command message may include security parameters, such as the ngKSI associated with the common NAS security context (exemplified as “ngKSI 1” in FIG. 4), and an indication to align NAS security contexts within the UE (exemplified as “indication to align” in FIG. 4).

In one embodiment, the indication to align NAS security contexts within the UE may be the HDP (e.g., the HDP in table 1) in the additional 5G security parameters IE according to the 3GPP TS 24.501, and the HDP may be set to a value (e.g., 1) representing “K_{AMF} derivation is not required”.

In another embodiment, the indication to align NAS security contexts within the UE may be a new parameter (e.g., the ALIGN in table 3) in the additional 5G security parameters IE according to the 3GPP TS 24.501, and the new parameter may be set to a value representing “Alignment of NAS security contexts is required”.

In block 407, the UE deletes the common NAS security context in use on the non-3GPP access.

In block 408, the UE takes the new NAS security context in use on the 3GPP access into use on the non-3GPP access. That is, the UE applies the security parameters in the new NAS security context for the non-3GPP access (i.e., uses the new NAS security context on both the 3GPP access and the non-3GPP access).

In block 409, the common NAS security context becomes aligned again on both the 3GPP access and the non-3GPP access.

In block 410, the UE sends a NAS Security Mode Complete message to the AMF over the non-3GPP access.

In view of the forgoing embodiments, it will be appreciated that the present application realizes robust UE operations on the occurrence of unaligned common NAS security context, by allowing the UE to receive explicit indication to align the NAS security contexts on both accesses when the common NAS security context is unaligned. Specifically, it is proposed to use an existing parameter (e.g., the KSI or the HDP in table 1) or a new parameter (e.g, the ALIGN in table 3) to provide the indication.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), communicatively connected to a 3rd Generation Partnership Project (3GPP) core network over a 3GPP access and a non-3GPP access and using a common Non Access Stratum (NAS) security context on both the 3GPP access and the non-3GPP access, comprising:
a wireless transceiver, configured to perform wireless transmission and reception to and from the 3GPP access and the non-3GPP access; and
a controller, configured to communicate with the 3GPP core network over the 3GPP access and the non-3GPP access via the wireless transceiver, wherein the communication with the 3GPP core network comprises:
receiving a first NAS Security Mode Command message or a NAS Container (NASC), which comprises an indication to change the common NAS security context, from the 3GPP core network over one of the 3GPP access and the non-3GPP access;
in response to receiving the first NAS Security Mode Command message or the NASC over the one access, activating a new NAS security context over the one access;
after activating the new NAS security context over the one access, receiving a second NAS Security Mode Command message, which comprises a Key Set Identifier (KSI) associated with the common NAS security context, from the 3GPP core network over the other access of the 3GPP access and the non-3GPP access; and
in response to receiving the second NAS Security Mode Command message over the other access, aligning the common NAS security context in use on the other access with the new NAS security context in use on the one access.

2. The UE of claim 1, wherein the aligning of the common NAS security context in use on the other access with the new NAS security context in use on the one access is performed in response to the second NAS Security Mode Command message comprising the KSI associated with the common NAS security context that is already in use on the other access.

3. The UE of claim 1, wherein the second NAS Security Mode Command message further comprises an indication to align NAS security contexts within the UE, and the aligning of the common NAS security context in use on the other access with the new NAS security context in use on the one access is performed in response to the second NAS Security Mode Command message comprising the indication to align NAS security contexts within the UE.

4. The UE of claim 3, wherein the indication to align NAS security contexts within the UE is a Horizontal Derivation Parameter (HDP) in an additional 5G security parameters Information Element (IE) according to the 3GPP Technical Specification (TS) 24.501, and the HDP is set to a value representing “K_{AMF} derivation is not required”.

5. The UE of claim 3, wherein the indication to align NAS security contexts within the UE is a new parameter in an additional 5G security parameters Information Element (IE) according to the 3GPP Technical Specification (TS) 24.501, and the new parameter is set to a value representing “Alignment of NAS security contexts is required”.

6. The UE of claim 1, wherein the indication to change the common NAS security context is a K_AMF_change_flag in the NASC according to the 3GPP Technical Specification (TS) 24.501, and the K_AMF_change_flag is set to a value representing that a new K_{AMF} has been calculated by the 3GPP core network.

7. The UE of claim 1, wherein the indication to change the common NAS security context is a Horizontal Derivation Parameter (HDP) in an additional 5G security parameters Information Element (IE) in the first NAS Security Mode Command message according to the 3GPP Technical Specification (TS) 24.501, and the HDP is set to a value representing that K_{AMF} derivation is required.

8. The UE of claim 1, wherein the indication to change the common NAS security context indicates at least one of:
a change to the KSI; and
a change to algorithms for integrity and ciphering in the common NAS security context.

9. The UE of claim 1, wherein, in response to the 3GPP core network being a 5G core network, the KSI is a first Key Set Identifier for Next Generation Radio Access Network (ngKSI) and the common NAS security context in use on the other access comprises the first ngKSI, a first security key K_{AMF}, and first algorithms for integrity protection and ciphering, while the new NAS security context in use on the one access comprises a second ngKSI, a second security key K′_{AMF}, and second algorithms for integrity protection and ciphering.

10. The UE of claim 1, wherein the aligning of the common NAS security context in use on the other access with the new NAS security context in use on the one access comprises:
deleting the common NAS security context in use on the other access; and
using the new NAS security context on both the one access and the other access.

11. A method for alignment of common Non Access Stratum (NAS) security context, executed by a User Equipment (UE) which is communicatively connected to a 3rd Generation Partnership Project (3GPP) core network over a 3GPP access and a non-3GPP access and is using a common NAS security context on both the 3GPP access and the non-3GPP access, the method comprising:
receiving a first NAS Security Mode Command message or a NAS Container (NASC), which comprises an indication to change the common NAS security context, from the 3GPP core network over one of the 3GPP access and the non-3GPP access;
in response to receiving the first NAS Security Mode Command message or the NASC over the one access, activating a new NAS security context over the one access;
after activating the new NAS security context over the one access, receiving a second NAS Security Mode Command message, which comprises a Key Set Identifier (KSI) associated with the common NAS security context, from the 3GPP core network over the other access of the 3GPP access and the non-3GPP access; and
in response to receiving the second NAS Security Mode Command message over the other access, aligning the common NAS security context in use on the other access with the new NAS security context in use on the one access.

12. The method of claim 11, wherein the aligning of the common NAS security context in use on the other access with the new NAS security context in use on the one access is performed in response to the second NAS Security Mode Command message comprising the KSI associated with the common NAS security context that is already in use on the other access.

13. The method of claim 11, wherein the second NAS Security Mode Command message further comprises an indication to align NAS security contexts within the UE, and the aligning of the common NAS security context in use on the other access with the new NAS security context in use on the one access is performed in response to the second NAS Security Mode Command message comprising the indication to align NAS security contexts within the UE.

14. The method of claim 13, wherein the indication to align NAS security contexts within the UE is a Horizontal Derivation Parameter (HDP) in an additional 5G security parameters Information Element (IE) according to the 3GPP Technical Specification (TS) 24.501, and the HDP is set to a value representing “K_{AMF} derivation is not required”.

15. The method of claim 13, wherein the indication to align NAS security contexts within the UE is a new parameter in an additional 5G security parameters Information Element (IE) according to the 3GPP Technical Specification (TS) 24.501, and the new parameter is set to a value representing “Alignment of NAS security contexts is required”.

16. The method of claim 11, wherein the indication to change the common NAS security context is a K_AMF_change_flag in the NASC according to the 3GPP Technical Specification (TS) 24.501, and the K_AMF_change_flag is set to a value representing that a new K_{AMF} has been calculated by the 3GPP core network.

17. The method of claim 11, wherein the indication to change the common NAS security context is a Horizontal Derivation Parameter (HDP) in an additional 5G security parameters Information Element (IE) in the first NAS Security Mode Command message according to the 3GPP Technical Specification (TS) 24.501, and the HDP is set to a value representing that K_{AMF} derivation is required.

18. The method of claim 11, wherein the indication to change the common NAS security context indicates at least one of:
a change to the KSI; and
a change to algorithms for integrity and ciphering in the common NAS security context.

19. The method of claim 11, wherein, in response to the 3GPP core network being a 5G core network, the KSI is a first Key Set Identifier for Next Generation Radio Access Network (ngKSI) and the common NAS security context in use on the other access comprises the first ngKSI, a first security key K_{AMF}, and first algorithms for integrity protection and ciphering, while the new NAS security context in use on the one access comprises a second ngKSI, a second security key K′_{AMF}, and second algorithms for integrity protection and ciphering.

20. The method of claim 11, wherein the aligning of the common NAS security context in use on the other access with the new NAS security context in use on the one access comprises:
deleting the common NAS security context in use on the other access; and
using the new NAS security context on both the one access and the other access.
